(19) United States
(12) Patent Application Publication
(10) Pub. No.: US 2025/0233204 A1
(43) Pub. Date: Jul. 17, 2025

(54) IONOGEL ELECTROLYTES FOR BATTERIES THAT CYCLE LITHIUM IONS AND BATTERIES INCLUDING THE SAME

(71) Applicant: GM GLOBAL TECHNOLOGY OPERATIONS LLC, Detroit, MI (US)

(72) Inventors: Zhe LI, Shanghai (CN); Qili SU, Shanghai (CN); Thomas A. YERSAK, Royal Oak, MI (US); Haijing LIU, Shanghai (CN)

(21) Appl. No.: 18/675,738

(22) Filed: May 28, 2024

(30) Foreign Application Priority Data
Jan. 16, 2024 (CN) 2024100669353

(51) Int. Cl. H01M 10/0565; H01M 4/02; H01M 4/36; H01M 4/38; H01M 4/62; H01M 10/0525; H01M 10/0562; H01M 10/0585; H01M 50/411; H01M 50/443; H01M 50/489

(52) U.S. Cl. CPC H01M 10/0565; H01M 4/366; H01M 4/386; H01M 4/62; H01M 10/0525; H01M 10/0562; H01M 10/0585; H01M 50/411; H01M 50/443; H01M 50/489; H01M 2004/027; H01M 2220/20; H01M 2300/0068; H01M 2300/008; H01M 2300/0085; H01M 2300/0091

(57) ABSTRACT

A battery that cycles lithium ions includes a negative electrode, a positive electrode, a separator disposed between the negative electrode and the positive electrode, and an ionogel electrolyte. The negative electrode includes electroactive material particles comprising silicon. The positive electrode includes an electroactive positive electrode material. The ionogel electrolyte includes a polymer matrix, an ionic liquid in the polymer matrix, and a lithium salt in the ionic liquid. The ionic liquid includes a cation including a piperidinium ion and an anion including bis(fluorosulfonyl)imide (FSI).

### CROSS-REFERENCE TO RELATED APPLICATIONS

This application claims the benefit of Chinese Patent Application No. 202410066935.3, filed on Jan. 16, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to ionogel electrolytes for batteries that comprise silicon-containing negative electrodes.

Lithium batteries are used in a wide variety of electronic devices and are a promising candidate to fulfill the requirements of electric vehicles, including hybrid electric vehicles, owing to their high energy and power densities. Secondary lithium batteries generally include a negative electrode, a positive electrode, and an electrolyte that provides a medium for the conduction of lithium ions between the negative and positive electrodes during discharge and charge of the battery. The electrolyte may be formulated to exhibit certain desirable properties including high ionic conductivity, good thermal stability, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, in accordance with one or more embodiments of the present disclosure, comprises a negative electrode, a positive electrode spaced apart from the negative electrode, a separator disposed between the negative electrode and the positive electrode, and an ionogel electrolyte. The negative electrode comprises electroactive material particles comprising silicon. The positive electrode comprises an electroactive positive electrode material. The ionogel electrolyte comprises a polymer matrix, an ionic liquid in the polymer matrix, and a lithium salt in the ionic liquid. The ionic liquid comprises a cation comprising a piperidinium ion and an anion comprising bis(fluorosulfonyl)imide (FSI).

The polymer matrix may comprise poly(vinylidene fluoride-co-hexafluoropropylene) (PVDF-HFP), polyvinylidene difluoride (PVDF), poly(vinylidene fluoride-co-tetrafluoroethylene) (PVDF-TFE), poly(ethylene oxide) (PEO), polyvinylpyrrolidone (PVP), poly(methyl methacrylate)s (PMMA), carboxymethyl cellulose (CMC), polyacrylonitrile (PAN), poly(vinyl alcohol) (PVA), or a combination thereof.

The polymer matrix may constitute, by weight, greater than or equal to 0.5% and less than or equal to 40% of the ionogel electrolyte.

The cation may comprise N-methyl-N-propylpyrrolidinium ([Py₁₃]⁺), 1-propyl-1-methylpiperidinium ([PP₁₃]⁺), 1-butyl-1-methylpiperidinium ([PP₁₄]⁺), 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), or a combination thereof.

The lithium salt may comprise lithium bis(fluorosulfonyl)imide (LiFSI).

The ionic liquid and the lithium salt may constitute, by weight, greater than or equal to 60% and less than or equal to 99.5% of the ionogel electrolyte.

The lithium salt may be present in the ionic liquid at a concentration of greater than or equal to 0.6 Molar and less than or equal to 4 Molar.

The electroactive material particles of the negative electrode may define open pores extending through the negative electrode, and the ionogel electrolyte may infiltrate the open pores defined by the electroactive material particles of the negative electrode.

The negative electrode may further comprise a solid electrolyte interphase formed in situ on surfaces of the electroactive material particles. The solid electrolyte interphase may comprise lithium fluoride (LiF), lithium silicate (LiₓSiO_{y}), or a combination thereof. The LiF may constitute, by weight, greater than or equal to 3% and less than or equal to 15% of the solid electrolyte interphase and the LiₓSiO_{y} may constitute, by weight, greater than or equal to 2% and less than or equal to 10% of the solid electrolyte interphase.

The negative electrode may further comprise a polymer binder and an electrically conductive material.

The separator may be a polymer membrane having an open microporous structure with open pores extending therethrough, and the ionogel electrolyte may infiltrate the open pores of the polymer membrane.

The separator may comprise solid electrolyte particles that define open pores extending through the separator from the negative electrode to the positive electrode, and the ionogel electrolyte may infiltrate the open pores defined by the solid electrolyte particles.

The negative electrode may further comprise solid electrolyte particles.

A battery that cycles lithium ions, in accordance with one or more embodiments of the present disclosure, comprises a negative electrode, a positive electrode spaced apart from the negative electrode, a separator disposed between the negative electrode and the positive electrode, and an ionogel electrolyte infiltrating the negative electrode, the positive electrode, and the separator. The negative electrode comprises electroactive material particles comprising silicon, the silicon constituting, by weight, greater than or equal to 5% of the electroactive material particles. The positive electrode comprises an electroactive positive electrode material. The ionogel electrolyte comprises a polymer matrix, an ionic liquid in the polymer matrix, and a lithium salt in the ionic liquid. The polymer matrix comprises poly(vinylidene fluoride-co-hexafluoropropylene) (PVDF-HFP). The polymer matrix constitutes, by weight, greater than or equal to 0.5% and less than or equal to 40% of the ionogel electrolyte. The ionic liquid comprises N-methyl-N-propylpyrrolidinium bis(fluorosulfonyl)imide (Py₁₃-FSI). The lithium salt comprises lithium bis(fluorosulfonyl)imide (LiFSI).

The negative electrode may further comprise a solid electrolyte interphase formed in situ on surfaces of the electroactive material particles. The solid electrolyte interphase may comprise lithium fluoride (LiF), lithium silicate (LiₓSiO_{y}), or a combination thereof.

A method of manufacturing a battery that cycles lithium ions, in accordance with one or more embodiments of the present disclosure, comprises infiltrating open pores of a negative electrode with an electrolyte precursor comprising a polymer matrix, an ionic liquid, a lithium salt, and a processing solvent, and then removing the processing solvent from the electrolyte precursor to form an ionogel electrolyte in the open pores of the negative electrode. The ionic liquid comprises a cation comprising a piperidinium ion and an anion comprising bis(fluorosulfonyl)imide (FSI). The lithium salt comprises lithium bis(fluorosulfonyl)imide (LiFSI). The ionogel electrolyte comprises the polymer matrix, the ionic liquid, and the lithium salt. The ionic liquid and the lithium salt are immobilized in the polymer matrix of the ionogel electrolyte.

The polymer matrix may comprise poly(vinylidene fluoride-co-hexafluoropropylene) (PVDF-HFP), polyvinylidene difluoride (PVDF), poly(vinylidene fluoride-co-tetrafluoroethylene) (PVDF-TFE), poly(ethylene oxide) (PEO), polyvinylpyrrolidone (PVP), poly(methyl methacrylate)s (PMMA), carboxymethyl cellulose (CMC), polyacrylonitrile (PAN), poly(vinyl alcohol) (PVA), or a combination thereof, and wherein the cation comprises N-methyl-N-propylpyrrolidinium ([Py₁₃]⁺), 1-propyl-1-methylpiperidinium ([PP₁₃]⁺), 1-butyl-1-methylpiperidinium ([PP₁₄]⁺), 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), or a combination thereof.

The method may further comprise preparing a polymer solution by mixing the polymer matrix and the processing solvent together at a temperature of greater than or equal to about 55 degrees Celsius and less than or equal to 100 degrees Celsius. The ionic liquid and the lithium salt may be introduced into the polymer solution to form the electrolyte precursor.

The method may further comprise, after the ionogel electrolyte is formed in the open pores of the negative electrode, assembling the negative electrode in a stack comprising a positive electrode and a separator to form the battery.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a negative electrode, a positive electrode, a separator in the form of a polymer membrane, and an ionogel electrolyte infiltrating pores of the negative electrode, the positive electrode, and the separator, the negative electrode comprising electroactive material particles.

FIG. 4 is a schematic cross-sectional view of one of the electroactive material particles of the negative electrode of FIG. 3, the electroactive material particle having a solid electrolyte interphase formed in situ on an exterior surface thereof.

FIG. 5 is a schematic cross-sectional view of a battery that cycles lithium ions, the battery comprising a negative electrode, a positive electrode, a separator defined by a plurality of solid electrolyte particles, and an ionogel electrolyte infiltrating pores of the negative electrode, the positive electrode, and the separator.

In the drawings, reference numbers may be reused to identify similar and/or identical elements.

### DETAILED DESCRIPTION

The presently disclosed ionogel electrolytes comprise an ionic liquid immobilized in a polymer matrix and can be used in batteries that cycle lithium ions to establish robust interfacial contact between the electroactive materials in the electrodes and the ionogel electrolyte, which may improve the electrochemical performance (e.g., the rate capability) of the batteries, as compared to batteries including ionic liquid electrolytes that do not comprise a polymer matrix. In addition, the presently disclosed ionogel electrolytes can more effectively wet the electroactive materials in the electrodes and thereby increase the amount of the electroactive materials that are available to participate in the electrochemical reactions occurring within the batteries, which, in turn, can increase the capacity of the batteries. Furthermore, when the presently disclosed ionogel electrolytes are used in combination with batteries that include silicon (Si)-containing negative electrodes, the ionogel electrolytes can promote the formation of stable solid electrolyte interphases (SEIs) on surfaces of the Si-containing electroactive materials in the negative electrodes, thereby improving the cycling stability of the batteries.

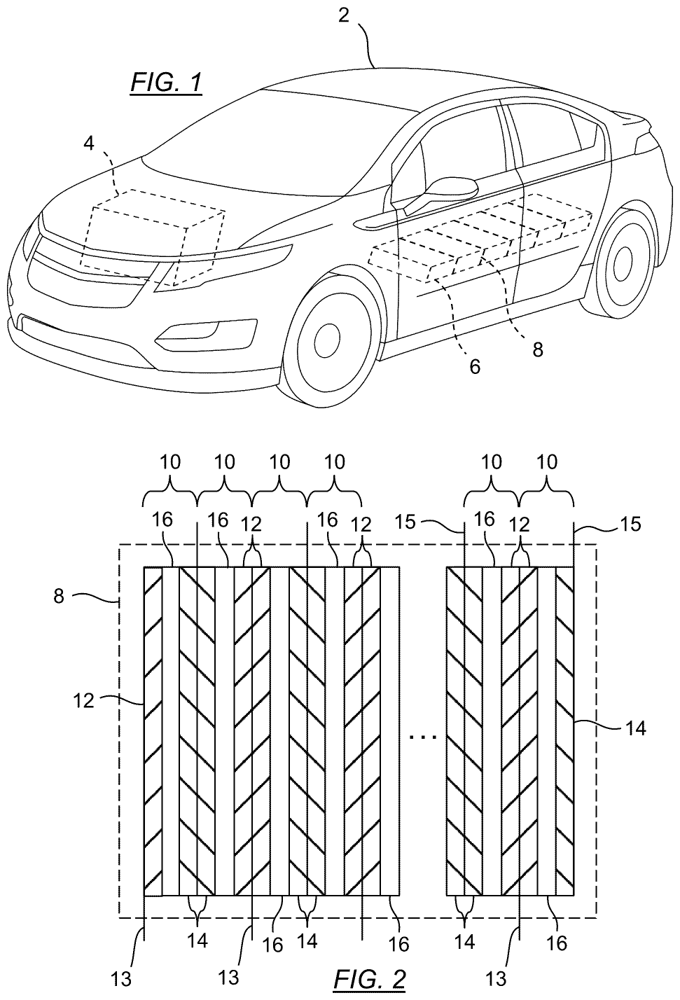

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

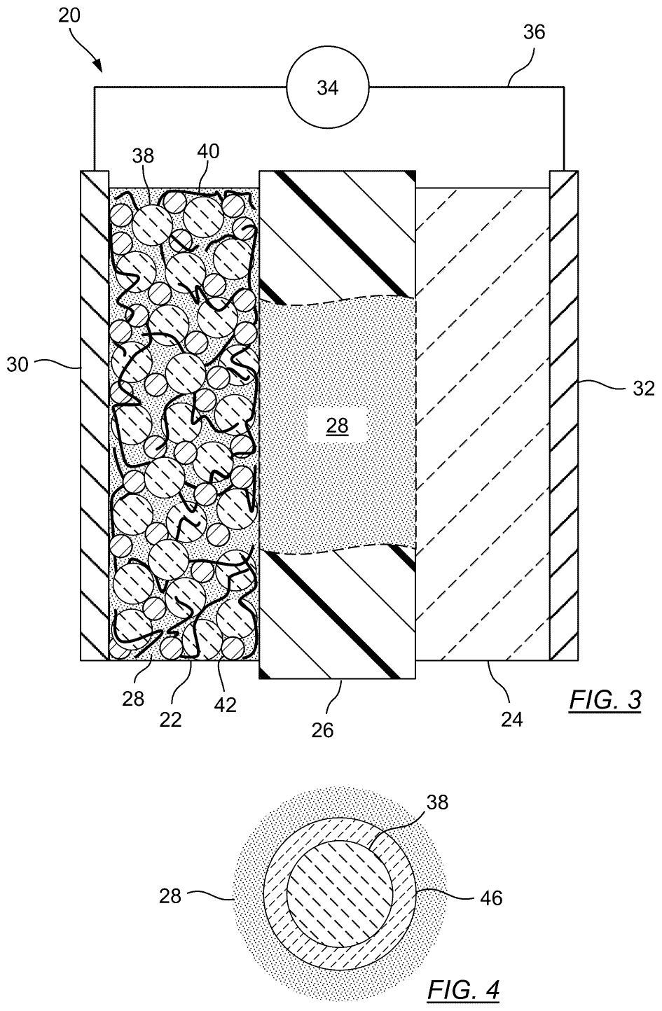

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an ionogel electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release lithium ions to facilitate charge and discharge, respectively, of the battery 20. The negative electrode 22 is disposed on a major surface of the negative electrode current collector 30 and may be in the form of a continuous porous layer having a plurality of open pores extending therethrough. The negative electrode 22 comprises electrochemically active (electroactive) material particles 38, a polymer binder 40, and optionally an electrically conductive material 42. The electroactive material particles 38 of the negative electrode 22 may be referred to herein as electroactive negative electrode material particles. The electroactive material particles 38 may be intermingled with the polymer binder 40 and the optional electrically conductive material 42 in the negative electrode 22. The negative electrode 22 may have a thickness of greater than or equal to 2 micrometers (μm), optionally greater than or equal to 10 μm, optionally greater than or equal to 20 μm, or optionally greater than or equal to 30 μm, and less than or equal to 200 μm.

The electroactive material particles 38 of the negative electrode 22 are made of an electroactive material that is formulated to store and release lithium ions by undergoing a reversible redox reaction with lithium during charge and discharge of the battery 20. Examples of electroactive materials for the negative electrode 22 include silicon, silicon-based materials (e.g., alloys of silicon and lithium, tin, iron, aluminum, and/or cobalt), silicon oxide, silicon oxide-based materials (e.g., lithium silicon oxide), lithium, lithium-based materials (e.g., alloys of lithium and silicon, aluminum, indium, and/or tin), carbon-based materials (e.g., graphite, activated carbon, carbon black, hard carbon, soft carbon, and/or graphene), tin oxide, aluminum, indium, zinc, germanium, titanium oxide, lithium titanate, and combinations thereof. The electroactive material particles 38 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

At least one of the electroactive materials used to form the electroactive material particles 38 of the negative electrode 22 is silicon. For example, in embodiments, silicon may constitute, by weight, greater than or equal to 5%, optionally greater than or equal to about 10%, and less than or equal to about 90% of the electroactive material particles 38 of the negative electrode 22.

The polymer binder 40 is electrochemically inactive and may provide the negative electrode 22 with structural integrity, for example, by promoting cohesion between the electroactive material particles 38 and/or by helping the negative electrode 22 adhere to the major surface of the negative electrode current collector 30. Examples of polymers that may be used to form the polymer binder 40 include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder 40 may constitute, by weight, greater than or equal to about 1%, or optionally greater than or equal to about 5%, and less than or equal to about 10% of the negative electrode 22.

The optional electrically conductive material 42 is electrochemically inactive and may provide the negative electrode 22 with good electrical conductivity. Examples of electrically conductive materials that may be used to form the optional electrically conductive material 42 of the negative electrode 22 include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the negative electrode 22, the optional electrically conductive material 42 may constitute, by weight, greater than 0%, optionally greater than or equal to about 1%, or optionally greater than or equal to about 5% and less than or equal to about 10% of the negative electrode 22.

The positive electrode 24 is formulated to store and release lithium ions during discharge and charge of the battery 20. The positive electrode 24 may be in the form of a continuous porous layer disposed on the major surface of the positive electrode current collector 32 and may comprise a plurality of open pores extending therethrough. The positive electrode 24 comprises an electroactive material (electroactive positive electrode material), a polymer binder, and optionally an electrically conductive material. The electroactive material of the positive electrode 24 may be a particulate material and particles of the electroactive material of the positive electrode 24 may be intermingled with the polymer binder and the optional electrically conductive material. The same polymer binders and/or electrically conductive materials disclosed above with respect to the negative electrode 22 may be used in the positive electrode 24 in substantially the same amounts.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt).

The separator 26 physically separates and electrically isolates the negative electrode 22 and the positive electrode 24 from each other while permitting lithium ions to pass therethrough. The separator 26 has an open microporous structure comprising a plurality of open pores and may comprise an organic and/or inorganic material. The separator 26 may have a thickness of greater than or equal to about 5 micrometers (μm), optionally greater than or equal to about 10 μm, or optionally greater than or equal to about 20 μm and less than or equal to about 200 μm, optionally less than or equal to about 100 μm, or optionally less than or equal to about 50 μm.

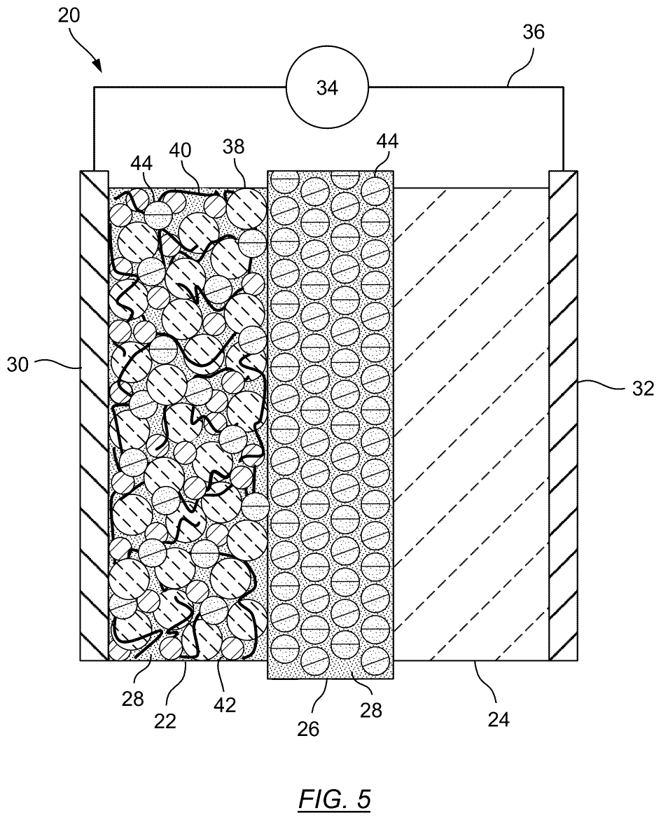

As shown in FIG. 3, in some embodiments, the separator 26 may be in the form of a polymer membrane. In embodiments where the separator 26 is in the form of a polymer membrane, the separator 25 may comprise a polyolefin (e.g., polyethylene, PE, and/or polypropylene, PP), polyamide (PA), poly(tetrafluoroethylene) (PTFE), polyvinylidene fluoride (PVDF), poly(vinyl chloride) (PVC), or a combination thereof. As shown in FIG. 5, in some embodiments, the separator 26 may be defined by a plurality of solid electrolyte particles 44. The solid electrolyte particles 44 comprise an inorganic solid electrolyte material that is formulated to conduct lithium ions in the solid-state by diffusion through their crystal lattice. Examples of inorganic solid electrolyte materials include oxides-, sulfides-, and phosphate-based materials. In some embodiments, the separator 26 may comprise both a polymer membrane and a plurality of the solid electrolyte particles 44 (not shown). As shown in FIG. 5, in embodiments where the separator 26 is defined by a plurality of the solid electrolyte particles 44, the negative electrode 22 and/or the positive electrode 24 may further comprise a plurality of the solid electrolyte particles 44. In such case, the solid electrolyte particles 44 may constitute, by weight, greater than 0%, optionally greater than or equal to 20%, and less than or equal to 30% of the negative electrode 22 and/or the positive electrode 24.

The ionogel electrolyte 28 is ionically conductive and provides a medium for the conduction of lithium ions through the negative electrode 22, the positive electrode 24, and the separator 26 and between the negative electrode 22 and the positive electrode 24. The ionogel electrolyte 28 may infiltrate the open pores of the negative electrode 22, the positive electrode 24, and the separator 26 and wet the surfaces thereof. The ionogel electrolyte 28 comprises a polymer matrix, an ionic liquid immobilized in the polymer matrix, and a lithium salt in the ionic liquid. In comparison to ionic liquid electrolytes (that include an ionic liquid and a lithium salt but do not include a polymer matrix), the ionogel electrolyte 28 (including the ionic liquid, the lithium salt, and the polymer matrix) can more thoroughly and effectively wet the electroactive material particles 38 of the negative electrode 22, thereby increasing the amount of the electroactive material particles 38 that are available to participate in the electrochemical reactions occurring within the battery 20 during operation thereof. As such, in comparison to ionic liquid electrolytes that do not include a polymer matrix, the ionogel electrolyte 28 (including the ionic liquid, the lithium salt, and the polymer matrix) can provide the battery 20 with improved rate capability and increased capacity.

The polymer matrix is formulated to provide the ionogel electrolyte 28 with flexibility and the ability to establish robust interfacial contact with the electroactive materials of the negative electrode 22 and with the positive electrode 24 (i.e., with the electroactive material particles 38 of the negative electrode 22). The polymer matrix may comprise poly(vinylidene fluoride-co-hexafluoropropylene) (PVDF-HFP), polyvinylidene difluoride (PVDF), poly(vinylidene fluoride-co-tetrafluoroethylene) (PVDF-TFE), poly(ethylene oxide) (PEO), polyvinylpyrrolidone (PVP), poly(methyl methacrylate)s (PMMA), carboxymethyl cellulose (CMC), polyacrylonitrile (PAN), poly(vinyl alcohol) (PVA), or a combination thereof. The polymer matrix may constitute, by weight, greater than or equal to 0.5%, optionally greater than or equal to 3%, and less than or equal to 40%, optionally less than or equal to 10%, of the ionogel electrolyte 28. In embodiments, the polymer matrix may constitute, by weight, about 5% of the ionogel electrolyte 28.

The ionic liquid infiltrates the polymer matrix and is formulated to provide the ionogel electrolyte 28 with high ionic conductivity, nonflammability, low volatility, and good electrochemical and thermal stability. The ionic liquid comprises a cation and an anion. The cation of the ionic liquid comprises a piperidinium ion. In embodiments, the cation of the ionic liquid may comprise N-methyl-N-propylpyrrolidinium ([Py₁₃]⁺), 1-propyl-1-methylpiperidinium ([PP₁₃]⁺), 1-butyl-1-methylpiperidinium ([PP₁₄]⁺), 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), or a combination thereof. The anion of the ionic liquid comprises bis(fluorosulfonyl)imide (N(SO₂F)₂⁻) (FSI⁻). The ionic liquid may constitute, by weight, greater than or equal to 40%, optionally greater than or equal to 50%, optionally greater than or equal to 60%, optionally greater than or equal to 70%, and less than or equal to 92% of the ionogel electrolyte 28. In embodiments, the ionic liquid may constitute, by weight, about 83.4% of the ionogel electrolyte 28.

The lithium salt is formulated to provide the ionogel electrolyte 28 with good ionic conductivity, for example, by generating lithium ion transport channels therethrough. The lithium salt may comprise a lithium sulfonylimide. In embodiments, the lithium salt comprises lithium bis(fluorosulfonyl)imide (LiN(FSO₂)₂) (LiFSI). When dissolved in the ionic liquid, the LiFSI dissociates to form Li⁺ cations and N(SO₂F)₂⁻ anions. The lithium salt may be present in the ionic liquid at a concentration of greater than or equal to 0.6 Molar and less than or equal to 4 Molar, optionally less than or equal to 2 Molar. In embodiments, the lithium salt may be present in the ionic liquid at a concentration of about 1 Molar. In embodiments, the lithium salt may constitute, by weight, greater than or equal to 7%, optionally greater than or equal to 10%, and less than or equal to 21.5%, or optionally less than or equal to 15% of the ionogel electrolyte 28. In embodiments, the lithium salt may constitute, by weight, about 11.6% of the ionogel electrolyte 28.

In combination, the ionic liquid and the lithium salt may constitute, by weight, greater than or equal to 60%, optionally greater than or equal to 80%, and less than or equal to 99.5%, optionally less than or equal to 98%, of the ionogel electrolyte 28. In embodiments, the ionic liquid and the lithium salt may constitute, by weight, about 95% of the ionogel electrolyte 28.

Referring now to FIG. 4, the N(SO₂F)₂⁻ anions in the ionogel electrolyte 28 are formulated to participate in the in situ formation of a solid electrolyte interphase 46 on surfaces 48 of each of the electroactive material particles 38 of the negative electrode 22 during initial and/or repeated cycling of the battery 20. The solid electrolyte interphase 46 is electrically insulating and ionically conductive and, when present, is configured to help prevent undesirable chemical reactions from occurring between the ionogel electrolyte 28 and the electroactive material particles 38 of the negative electrode 22 during cycling of the battery 20. During formation of the solid electrolyte interphase 46, the N(SO₂F)₂⁻ anions in the ionogel electrolyte 28 may react with the silicon and the lithium in the electroactive material particles 38 of the negative electrode 22 and decompose to form inorganic compounds, such as lithium fluoride (LiF), lithium silicate (LiₓSiO_{y}), lithium silicide (LiₓSi), and combinations thereof. The inorganic decomposition products of the N(SO₂CF₃)₂⁻ anions may deposit on the surfaces 48 of the electroactive material particles 38 and form the solid electrolyte interphase 46. As such, the solid electrolyte interphase 46 may comprise lithium fluoride (LiF), lithium silicate (LiₓSiO_{y}), lithium silicide (LiₓSi), and combinations thereof. In embodiments, the LiF may constitute, by weight, greater than or equal to 3% and less than or equal to 15% of the solid electrolyte interphase 46 and the LiₓSiO_{y} may constitute, by weight, greater than or equal to 2% and less than or equal to 10% of the solid electrolyte interphase 46. For example, in embodiments, the LiF may constitute, by weight, about 6% of the solid electrolyte interphase 46 and the LiₓSiO_{y} may constitute, by weight, about 5% of the solid electrolyte interphase 46.

In embodiments, the ionogel electrolyte 28 may be substantially free of lithium bis(trifluoromethanesulfonyl)imide (LiTFSI) and may be substantially free of bis(trifluoromethanesulfonyl)imide N(SO₂CF₃)₂⁻ anions. Without intending to be bound by theory, it is believed that, when silicon is used as an electroactive negative electrode material and N(SO₂CF₃)₂⁻ anions are included in the electrolyte of a battery that cycles lithium ions (such as the battery 20), the N(SO₂CF₃)₂⁻ anions may decompose on the surface of the electroactive negative electrode material during cycling of the battery and form organic compounds (e.g., SO₂CF₃⁻ and NSO₂CF₃²⁻), which may lead to the formation of a relatively thick and unstable solid electrolyte interphase on surfaces of the electroactive negative electrode material, as compared to batteries in which N(SO₂F)₂⁻ anions are included in the electrolyte (such as in the ionogel electrolyte 28). The formation of the relatively thick, unstable organic compound-containing solid electrolyte interphase on the surfaces of the electroactive negative electrode material may lead to rapid capacity fade.

In addition, in embodiments, the ionogel electrolyte 28 may be substantially free of nonaqueous aprotic organic solvents. Non-limiting examples of non-aqueous aprotic organic solvents that may be excluded from the composition of the ionogel electrolyte 28 include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

### Methods

The ionogel electrolyte 28 may be manufactured by preparing an electrolyte precursor comprising the polymer matrix, the ionic liquid, the lithium salt, and a processing solvent. The polymer matrix, the ionic liquid, and the lithium salt may have substantially the same composition as the polymer matrix, the ionic liquid, and the lithium salt included in the ionogel electrolyte 28 and may be present in the electrolyte precursor in substantially the same proportions.

The processing solvent may comprise an organic solvent having a low vapor pressure so that the processing solvent may be readily removed from the precursor electrolyte by evaporation at temperatures less than or equal to 100 degrees Celsius (° C.). Examples of processing solvents include dimethyl carbonate (DMC), ethyl methyl carbonate (EMC), diethyl carbonate (DEC), methyl propyl carbonate (MPC), tetrahydrofuran (THF), ethyl acetate, dimethyl sulfoxide, acetonitrile (ACN), N-methyl-2-pyrrolidone (NMP), dimethoxyethane, dioxolane, acetone, N,N-dimethylformamide (DMF), alcohols (e.g., ethanol, methanol, and/or isopropanol), and combinations thereof. The processing solvent may constitute, by weight, greater than or equal to 15% and less than or equal to 85% of the precursor electrolyte.

In embodiments, the precursor electrolyte may be prepared by mixing the polymer matrix and the processing solvent together to form a polymer solution, and separately mixing the ionic liquid and the lithium salt together to form an ionic liquid mixture. Then, the ionic liquid mixture may be introduced into the polymer solution to form the precursor electrolyte. In embodiments, the polymer matrix and the processing solvent may be mixed together at a temperature of greater than or equal to about 55° C. and less than or equal to 100° C. to form the polymer solution.

During assembly of the battery 20, the precursor electrolyte may be introduced into the open pores of the negative electrode 22, the positive electrode 24, and/or the separator 26, and then the processing solvent may be removed from the precursor electrolyte to form the ionogel electrolyte 28 in the open pores of the negative electrode 22, the positive electrode 24, and/or the separator 26. The processing solvent may be removed from the precursor electrolyte, for example, at a temperature of greater than or equal to 10° C. and less than or equal to 100° C. (e.g., ambient temperature, about 25° C.) for a duration of greater than or equal to 30 minutes and less than or equal to 24 hours. In embodiments, the ionogel electrolyte 28 may be separately formed in the open pores of each of the negative electrode 22, the positive electrode 24, and/or the separator 26 individually, and then the negative electrode 22, the positive electrode 24, and the separator 26 may be assembled into the form of the battery 20.

In embodiments, the precursor electrolyte may be introduced into the open pores of the negative electrode 22, the positive electrode 24, and/or the separator 26 by depositing the precursor electrolyte on the negative electrode 22, the positive electrode 24, and/or the separator 26 such that the precursor electrolyte infiltrates the open pores of the negative electrode 22, the positive electrode 24, and/or the separator 26. The precursor electrolyte may be deposited on the negative electrode 22, the positive electrode 24, and/or the separator 26, for example, by drop coating, dip coating, spray coating, doctor blade coating, or a combination thereof.

In embodiments, the negative electrode 22 may be formed on a substrate, the precursor electrolyte may be introduced into the open pores of the negative electrode 22, and then the processing solvent may be removed from the precursor electrolyte to form the ionogel electrolyte 28 in the open pores of the negative electrode 22. In embodiments, the substrate may have substantially the same composition as that of the negative electrode current collector 30 and, after the ionogel electrolyte 28 is formed in the open pores of the negative electrode 22, the negative electrode 22 and the substrate may be assembled into the battery 20 wherein the substrate is the negative electrode current collector 30.

In some embodiments, the negative electrode 22, the positive electrode 24, and/or the separator 26 may be formed or disposed on a release film, the ionogel electrolyte 28 may be formed in the open pores of the negative electrode 22, the positive electrode 24, and/or the separator 26, and then the negative electrode 22, the positive electrode 24, and/or the separator 26 may be removed from the release film and assembled into the battery 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A battery that cycles lithium ions, the battery comprising:
a negative electrode comprising electroactive material particles comprising silicon;
a positive electrode spaced apart from the negative electrode and comprising an electroactive positive electrode material;
a separator disposed between the negative electrode and the positive electrode; and
an ionogel electrolyte comprising:
a polymer matrix;
an ionic liquid in the polymer matrix, the ionic liquid comprising a cation comprising a piperidinium ion and an anion comprising bis(fluorosulfonyl)imide (FSI); and
a lithium salt in the ionic liquid.

2. The battery of claim 1, wherein the polymer matrix comprises poly(vinylidene fluoride-co-hexafluoropropylene) (PVDF-HFP), polyvinylidene difluoride (PVDF), poly(vinylidene fluoride-co-tetrafluoroethylene) (PVDF-TFE), poly(ethylene oxide) (PEO), polyvinylpyrrolidone (PVP), poly(methyl methacrylate)s (PMMA), carboxymethyl cellulose (CMC), polyacrylonitrile (PAN), poly(vinyl alcohol) (PVA), or a combination thereof.

3. The battery of claim 1, wherein the polymer matrix constitutes, by weight, greater than or equal to 0.5% and less than or equal to 40% of the ionogel electrolyte.

4. The battery of claim 1, wherein the cation comprises N-methyl-N-propylpyrrolidinium ([Py₁₃]⁺), 1-propyl-1-methylpiperidinium ([PP₁₃]⁺), 1-butyl-1-methylpiperidinium ([PP₁₄]⁺), 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), or a combination thereof.

5. The battery of claim 1, wherein the lithium salt comprises lithium bis(fluorosulfonyl)imide (LiFSI).

6. The battery of claim 1, wherein the ionic liquid and the lithium salt constitute, by weight, greater than or equal to 60% and less than or equal to 99.5% of the ionogel electrolyte.

7. The battery of claim 1, wherein the lithium salt is present in the ionic liquid at a concentration of greater than or equal to 0.6 Molar and less than or equal to 4 Molar.

8. The battery of claim 1, wherein the electroactive material particles of the negative electrode define open pores extending through the negative electrode, and wherein the ionogel electrolyte infiltrates the open pores defined by the electroactive material particles of the negative electrode.

9. The battery of claim 1, wherein the negative electrode further comprises a solid electrolyte interphase formed in situ on surfaces of the electroactive material particles, and wherein the solid electrolyte interphase comprises lithium fluoride (LiF), lithium silicate (LiₓSiO_{y}), or a combination thereof.

10. The battery of claim 9, wherein the LiF constitutes, by weight, greater than or equal to 3% and less than or equal to 15% of the solid electrolyte interphase and the LiₓSiO_{y} constitutes, by weight, greater than or equal to 2% and less than or equal to 10% of the solid electrolyte interphase.

11. The battery of claim 1, wherein the negative electrode further comprises a polymer binder and an electrically conductive material.

12. The battery of claim 1, wherein the separator is a polymer membrane having an open microporous structure with open pores extending therethrough, and wherein the ionogel electrolyte infiltrates the open pores of the polymer membrane.

13. The battery of claim 1, wherein the separator comprises solid electrolyte particles that define open pores extending through the separator from the negative electrode to the positive electrode, and wherein the ionogel electrolyte infiltrates the open pores defined by the solid electrolyte particles.

14. The battery of claim 13, wherein the negative electrode further comprises solid electrolyte particles.

15. A battery that cycles lithium ions, the battery comprising:
a negative electrode comprising electroactive material particles comprising silicon, the silicon constituting, by weight, greater than or equal to 5% of the electroactive material particles;
a positive electrode spaced apart from the negative electrode and comprising an electroactive positive electrode material;
a separator disposed between the negative electrode and the positive electrode; and
an ionogel electrolyte infiltrating the negative electrode, the positive electrode, and the separator, the ionogel electrolyte comprising:
a polymer matrix comprising poly(vinylidene fluoride-co-hexafluoropropylene) (PVDF-HFP), the polymer matrix constituting, by weight, greater than or equal to 0.5% and less than or equal to 40% of the ionogel electrolyte;
an ionic liquid in the polymer matrix, the ionic liquid comprising N-methyl-N-propylpyrrolidinium bis(fluorosulfonyl)imide (Py₁₃-FSI); and
a lithium salt in the ionic liquid, the lithium salt comprising lithium bis(fluorosulfonyl)imide (LiFSI).

16. The battery of claim 15, wherein the negative electrode further comprises a solid electrolyte interphase formed in situ on surfaces of the electroactive material particles, and wherein the solid electrolyte interphase comprises lithium fluoride (LiF), lithium silicate (LiₓSiO_{y}), or a combination thereof.

17. A method of manufacturing a battery that cycles lithium ions, the method comprising:
infiltrating open pores of a negative electrode with an electrolyte precursor comprising a polymer matrix, an ionic liquid, a lithium salt, and a processing solvent, the ionic liquid comprising a cation comprising a piperidinium ion and an anion comprising bis(fluorosulfonyl)imide (FSI), the lithium salt comprising lithium bis(fluorosulfonyl)imide (LiFSI); and then
removing the processing solvent from the electrolyte precursor to form an ionogel electrolyte in the open pores of the negative electrode, the ionogel electrolyte comprising the polymer matrix, the ionic liquid, and the lithium salt,
wherein the ionic liquid and the lithium salt are immobilized in the polymer matrix of the ionogel electrolyte.

18. The method of claim 17, wherein the polymer matrix comprises poly(vinylidene fluoride-co-hexafluoropropylene) (PVDF-HFP), polyvinylidene difluoride (PVDF), poly(vinylidene fluoride-co-tetrafluoroethylene) (PVDF-TFE), poly(ethylene oxide) (PEO), polyvinylpyrrolidone (PVP), poly(methyl methacrylate)s (PMMA), carboxymethyl cellulose (CMC), polyacrylonitrile (PAN), poly(vinyl alcohol) (PVA), or a combination thereof, and wherein the cation comprises N-methyl-N-propylpyrrolidinium ([Py₁₃]⁺), 1-propyl-1-methylpiperidinium ([PP₁₃]⁺), 1-butyl-1-methylpiperidinium ([PP₁₄]⁺), 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), or a combination thereof.

19. The method of claim 17, further comprising:
preparing a polymer solution by mixing the polymer matrix and the processing solvent together at a temperature of greater than or equal to about 55 degrees Celsius and less than or equal to 100 degrees Celsius; and
introducing the ionic liquid and the lithium salt into the polymer solution to form the electrolyte precursor.

20. The method of claim 17, further comprising:
after the ionogel electrolyte is formed in the open pores of the negative electrode, assembling the negative electrode in a stack comprising a positive electrode and a separator to form the battery.
